(19) United States
(12) Patent Application Publication
(10) Pub. No.: US 2025/0131613 A1
(43) Pub. Date: Apr. 24, 2025

(54) VIDEO GENERATION METHOD, AND TRAINING METHOD FOR VIDEO GENERATION MODEL

(71) Applicant: Lemon Inc., Grand Cayman (KY)

(72) Inventors: Yizhe ZHU, Los Angeles, CA (US); Bingchen LIU, Los Angeles, CA (US); Xiao YANG, Los Angeles, CA (US)

(21) Appl. No.: 18/834,154

(22) PCT Filed: Dec. 15, 2022
(86) PCT No.: PCT/SG2022/050907

§ 371 Date: Jul. 29, 2024

(30) Foreign Application Priority Data
Jan. 29, 2022 (CN) 202210109748.X

(51) Int. Cl. G06T 11/00; G06T 7/194

(52) U.S. Cl. CPC G06T 11/001; G06T 7/194; G06T 2211/441

(57) ABSTRACT

Provided in the embodiments of the present disclosure are a video generation method, and a training method for a video generation model. The video generation method includes: acquiring a first video, wherein the first video includes a first object image; and inputting the first video into a pre-trained video generation model to obtain a second video, wherein the video generation model is obtained by means of performing training on the basis of a target image and a plurality of sample image pairs obtained from a plurality of first sample images, an object image in the second video is generated on the basis of a preset animal image in the target image and the first object image, and a background image of the second video is generated on the basis of a first background image of the first video.

### CROSS-REFERENCE TO RELATED APPLICATION

The present application claims priority to a Chinese patent application filed with the China Patent Office on Jan. 29, 2022, with application number 202210109748.X and application title “Video Generation Method and Training Method for Video Generation Model”, and the entire content of which is incorporated by reference in this article.

### TECHNICAL FIELD

The present disclosure relates to the technical field of image processing, in particular to a video generation method and a training method for a video generation model.

### BACKGROUND

At present, for a video including a facial image of a family pet, special effect changes may be applied to the facial image of the family pet in the video to change the facial image of the family pet in the video into facial images of other specific animals.

In related technologies, designers design a three-dimensional (3D) animal facial image prop as the facial images of the other specific animals, and replace the facial image of the family pet included in the video with the 3D animal facial image prop, to obtain a new video.

In the above process, the 3D animal facial image prop is used to replace the facial image of the family pet included in the video, to obtain the new video. This results in poor combination between the 3D animal facial image prop and the facial image of the family pet in the new video, leading to the poor quality of the new video.

### SUMMARY

Embodiments of the present disclosure provide a video generation method and a training method for a video generation model to solve the problem of poor quality of a new video.

In a first aspect, an embodiment of the present disclosure provides a video generation method, including:
acquiring a first video, wherein the first video includes a first object image; and
inputting the first video into a pre-trained video generation model, to obtain a second video, wherein the video generation model is obtained by training a plurality of sample image pairs obtained based on a target image and a plurality of first sample images, the object image in the second video is generated based on a preset animal image in the target image and the first object image, and a background image of the second video is generated based on a first background image of the first video.

In some embodiments, each of the plurality sample image pairs includes one of the plurality of first sample images and a second sample image corresponding to the first sample image; and
the second sample image is obtained based on the first sample image, the target image, and a first sample background image corresponding to the first sample image.

In some embodiments, the first sample image includes a first sample object image and an initial background image; the first sample object image and the initial background image do not overlap; and
the first sample background image is an image obtained after performing background supplementation processing on the initial background image.

In some embodiments, the second sample image is obtained based on the first sample background image and an object foreground image of an object image in a third sample image; and
the third sample image is obtained based on the first sample image and the target image, and the object image in the third sample image is generated based on the preset animal image and the first sample object image.

In some embodiments, the second sample image is obtained by performing fusion processing on the first sample background image and the object foreground image.

In some embodiments, the second sample image is obtained based on color difference information and a fourth sample image; the color difference information is obtained based on the fourth sample image and the first sample image; and the fourth sample image is obtained based on the object foreground image and the first sample background image.

In some embodiments, the color difference information includes a first color value corresponding to an R channel, a first color value corresponding to a G channel, and a first color value corresponding to a B channel;
the first color value corresponding to the R channel is obtained based on a second color value corresponding to the R channel and a third color value corresponding to the R channel, the first color value corresponding to the G channel is obtained based on a second color value corresponding to the G channel and a third color value corresponding to the G channel, and the first color value corresponding to the B channel is obtained based on a second color value corresponding to the B channel and a third color value corresponding to the B channel;
the second color value corresponding to the R channel, the second color value corresponding to the G channel, and the second color value corresponding to the B channel are obtained based on a color value of a pixel included in the fourth sample image respectively; and
the third color value corresponding to the R channel, the third color value corresponding to the G channel, and the third color value corresponding to the B channel are obtained based on a color value of a pixel included in the first sample image respectively.

In a second aspect, an embodiment of the present disclosure provides a training method for a video generation model, including:
acquiring a plurality of first sample images and a target image;
determining a first sample background image corresponding to each first sample image of the plurality of first sample images;
generating, for each first sample image, a second sample image according to the first sample image, the target image, and the corresponding first sample background image; and
determining the first sample image and the second sample image as a sample image pair, wherein an object image in the second sample image is generated based on a preset animal image in the target image and a first sample object image in the first sample image, and a background image of the second sample image is generated based on the corresponding first sample background image; and
training an initial video generation model according to a plurality of the sample image pairs, to obtain the video generation model.

In some embodiments, the determining the first sample background image corresponding to each first sample image of the plurality of first sample images, including:
acquiring, for each first sample image, an initial background image from the first sample image which excludes the first sample object image; and
performing background supplementation processing on the initial background image, to obtain a first sample background image corresponding to the first sample image.

In some embodiments, the generating the second sample image according to the first sample image, the target image, and the corresponding first sample background image, includes:
processing the first sample image and the target image by using a preset image generation model, to obtain a third sample image, wherein an object image in the third sample image is generated based on the preset animal image and the first sample object image;
acquiring an object foreground image of the object image in the third sample image; and
according to the object foreground image and the first sample background image, determining the second sample image.

In some embodiments, the determining the second sample image according to the object foreground image and the first sample background image, including:
performing fusion processing on the object foreground image and the first sample background image, to obtain the second sample image.

In some embodiments, the determining the second sample image according to the object foreground image and the first sample background image, including:
performing fusion processing on the object foreground image and the first sample background image, to obtain a fourth sample image;
acquiring color difference information between the fourth sample image and the first sample image; and
performing color adjustment on the fourth sample image according to the color difference information, to obtain the second sample image.

In some embodiments, the color difference information includes a first color value corresponding to an R channel, a first color value corresponding to a G channel, and a first color value corresponding to a B channel; the acquiring the color difference information between the fourth sample image and the first sample image includes:
performing statistical processing on a color value of a pixel included in the fourth sample image, to obtain a second color value corresponding to the R channel, a second color value corresponding to the G channel, and a second color value corresponding to the B channel;
performing statistical processing on a color value of a pixel included in the first sample image, to obtain a third color value corresponding to the R channel, a third color value corresponding to the G channel, and a third color value corresponding to the B channel;
determining a difference value between the second color value corresponding to the R channel and the third color value corresponding to the R channel as the first color value corresponding to the R channel;
determining a difference value between the second color value corresponding to the G channel and the third color value corresponding to the G channel as the first color value corresponding to the G channel; and
determining a difference value between the second color value corresponding to the B channel and the third color value corresponding to the B channel as the first color value corresponding to the B channel.

In some embodiments, the performing the color adjustment on the fourth sample image according to the color difference information, to obtain the second sample image, including:
for each pixel included in the fourth sample image, according to the first color value corresponding to the R channel, the first color value corresponding to the G channel, and the first color value corresponding to the B channel included in the color difference information, performing adjustment on a color value of the pixel, to obtain the second sample image.

In a third aspect, an embodiment of the present disclosure provides a video generation apparatus including a processing module, the processing module is configured to:
acquire a first video, wherein the first video includes a first object image; and
input the first video into a pre-trained video generation model, to obtain a second video, wherein the video generation model is obtained by training a plurality of sample image pairs obtained based on a target image and a plurality of first sample images, the object image in the second video is generated based on a preset animal image in the target image and the first object image, and a background image of the second video is generated based on a first background image of the first video.

In some embodiments, each of the plurality sample image pairs includes one of the plurality of first sample images and a second sample image corresponding to the first sample image; and the second sample image is obtained based on the first sample image, the target image, and a first sample background image corresponding to the first sample image.

In some embodiments, the first sample image includes a first sample object image and an initial background image; the first sample object image and the initial background image do not overlap; and the first sample background image is an image obtained after performing background supplementation processing on the initial background image.

In some embodiments, the second sample image is obtained based on the first sample background image and an object foreground image of an object image in a third sample image; and the third sample image is obtained based on the first sample image and the target image, and the object image in the third sample image is generated based on the preset animal image and the first sample object image.

In some embodiments, the second sample image is obtained by performing fusion processing on the first sample background image and the object foreground image.

In some embodiments, the second sample image is obtained based on color difference information and a fourth sample image; the color difference information is obtained based on the fourth sample image and the first sample image; and the fourth sample image is obtained based on the object foreground image and the first sample background image.

In some embodiments, the color difference information includes a first color value corresponding to an R channel, a first color value corresponding to a G channel, and a first color value corresponding to a B channel; the first color value corresponding to the R channel is obtained based on a second color value corresponding to the R channel and a third color value corresponding to the R channel, the first color value corresponding to the G channel is obtained based on a second color value corresponding to the G channel and a third color value corresponding to the G channel, and the first color value corresponding to the B channel is obtained based on a second color value corresponding to the B channel and a third color value corresponding to the B channel;
the second color value corresponding to the R channel, the second color value corresponding to the G channel, and the second color value corresponding to the B channel are obtained based on a color value of a pixel included in the fourth sample image respectively; and
the third color value corresponding to the R channel, the third color value corresponding to the G channel, and the third color value corresponding to the B channel are obtained based on a color value of a pixel included in the first sample image respectively.

In a fourth aspect, an embodiment of the present disclosure provides a training apparatus for a video generation model, including a processing module, the processing module is configured to:
acquire a plurality of first sample images and a target image;
determine a first sample background image corresponding to each first sample image of the plurality of first sample images;
generate, for each first sample image, a second sample image according to the first sample image, the target image, and the corresponding first sample background image; and determine the first sample image and the second sample image as a sample image pair, wherein an object image in the second sample image is generated based on a preset animal image in the target image and a first sample object image in the first sample image, and a background image of the second sample image is generated based on the corresponding first sample background image; and
train an initial video generation model according to a plurality of the sample image pairs, to obtain the video generation model.

In some embodiments, the determining the first sample background image corresponding to each first sample image of the plurality of first sample images, including:
acquiring, for each first sample image, an initial background image from the first sample image which excludes the first sample object image; and
performing background supplementation processing on the initial background image, to obtain a first sample background image corresponding to the first sample image.

In some embodiments, the processing module is specifically configured to:
process the first sample image and the target image by using a preset image generation model, to obtain a third sample image, wherein an object image in the third sample image is generated based on the preset animal image and the first sample object image;
acquire an object foreground image of the object image in the third sample image; and
according to the object foreground image and the first sample background image, determine the second sample image.

In some embodiments, the processing module is specifically configured to:
perform fusion processing on the object foreground image and the first sample background image, to obtain the second sample image.

In some embodiments, the processing module is specifically configured to:
perform fusion processing on the object foreground image and the first sample background image, to obtain a fourth sample image;
acquire color difference information between the fourth sample image and the first sample image; and
perform color adjustment on the fourth sample image according to the color difference information, to obtain the second sample image.

In some embodiments, the color difference information includes a first color value corresponding to an R channel, a first color value corresponding to a G channel, and a first color value corresponding to a B channel; the processing module is specifically configured to:
perform statistical processing on a color value of a pixel included in the fourth sample image, to obtain a second color value corresponding to the R channel, a second color value corresponding to the G channel, and a second color value corresponding to the B channel;
perform statistical processing on a color value of a pixel included in the first sample image, to obtain a third color value corresponding to the R channel, a third color value corresponding to the G channel, and a third color value corresponding to the B channel;
determine a difference value between the second color value corresponding to the R channel and the third color value corresponding to the R channel as the first color value corresponding to the R channel;
determine a difference value between the second color value corresponding to the G channel and the third color value corresponding to the G channel as the first color value corresponding to the G channel; and
determine a difference value between the second color value corresponding to the B channel and the third color value corresponding to the B channel as the first color value corresponding to the B channel.

In some embodiments, the processing module is specifically configured to:
for each pixel included in the fourth sample image, according to the first color value corresponding to the R channel, the first color value corresponding to the G channel, and the first color value corresponding to the B channel included in the color difference information, performing adjustment on a color value of the pixel, to obtain the second sample image.

In a fifth aspect, an embodiment of the present disclosure provides an image generation apparatus, including: a preset image segmentation module, a preset background supplementation module, a preset image generation module, and a foreground-background fusion module; wherein
the preset image segmentation module is used to perform image segmentation processing on a first sample image using a preset image segmentation model, to obtain an initial background image from the first sample image which excludes a first sample object image;
the preset background supplementation module is used to perform background supplementation processing on the initial background image using a preset background supplementation model, to obtain a first sample background image;
the preset image generation module is used to process the first sample image and a target image, to obtain a third sample image;
the preset image segmentation module is further used to perform image segmentation processing on the third sample image using the preset image segmentation model, to obtain an object foreground image; and
the foreground-background fusion module is used to perform fusion processing on the object foreground image and the first sample background image, to obtain a second sample image.

In a sixth aspect, an embodiment of the present disclosure provides an image generation apparatus, including: a preset image segmentation module, a preset background supplementation module, a preset image generation module, a foreground-background fusion module, and a color processing module; wherein
the preset image segmentation module is used to perform image segmentation processing on a first sample image using a preset image segmentation model, to obtain an initial background image from the first sample image which excludes a first sample object image;
the preset background supplementation module is used to perform background supplementation processing on the initial background image using a preset background supplementation model, to obtain a first sample background image;
the preset image generation module is used to process the first sample image and a target image, to obtain a third sample image;
the preset image segmentation module is further used to perform image segmentation processing on the third sample image using the preset image segmentation model, to obtain an object foreground image;
the foreground-background fusion module is used to perform fusion processing on the object foreground image and the first sample background image, to obtain a fourth sample image; and
the color processing module is used to obtain color difference information between the fourth sample image and the first sample image, and perform color adjustment on the fourth sample image according to the color difference information, to obtain a second sample image.

In a seventh aspect, an embodiment of the present disclosure provides an electronic device including a processor and a memory connected in communication with the processor, the memory stores computer execution instructions, and the processor executes the computer execution instructions stored in the memory to implement the method as described in the first aspect and various possible designs of the first aspect.

In an eighth aspect, an embodiment of the present disclosure provides a model training device including a processor and a memory connected in communication with the processor, the memory stores computer execution instructions; and the processor executes the computer execution instructions stored in the memory to implement the method as described in the second aspect and various possible designs of the second aspect.

In an ninth aspect, an embodiment of the present disclosure provides a computer-readable storage medium, wherein the computer-readable storage medium stores computer execution instructions, and when the computer execution instructions are executed by a processor, the method as described in various possible designs of the first aspect, the second aspect or the various aspects are implemented.

In an tenth aspect, an embodiment of the present disclosure provides a computer program product including a computer program, wherein when the computer program is executed by a processor, the method as described in various possible designs of the first aspect, the second aspect or the various aspects are implemented.

In an eleventh aspect, an embodiment of the present disclosure provides a computer program, wherein when the computer program is executed by a processor, the method as described in various possible designs of the first aspect, the second aspect or the various aspects are implemented.

An embodiment of the present disclosure provides a video generation method and a training method for a video generation model, the video generation method including: acquiring a first video, wherein the first video includes a first object image; and inputting the first video into a pre-trained video generation model, to obtain a second video, wherein the video generation model is obtained by training a plurality of sample image pairs obtained based on a target image and a plurality of first sample images, the object image in the second video is generated based on a preset animal image in the target image and the first object image, and a background image of the second video is generated based on a first background image of the first video. In the above method, an object image in a second video is obtained on the basis of good combination between a preset animal image and a first object image, and a background image of the second video is generated based on a first background image of a first video, rather than simply replacing the first object image with the preset animal image to obtain the object image in the second video. Therefore, the quality of the second video may be improved.

### BRIEF DESCRIPTION OF THE DRAWINGS

Drawings here are incorporated into the description and constitute a part of the description, and embodiments in accordance with the present disclosure are shown and used together with the description to explain the principles of the present disclosure.

FIG. 1 is a schematic diagram of an application scene of a video generation method provided in an embodiment of the present disclosure;

FIG. 2 is a flow diagram of the video generation method provided in the present disclosure;

FIG. 3 is a flow diagram of a training method for a video generation model provided in the present disclosure;

FIG. 4 is a schematic diagram of a first sample background image provided in an embodiment of the present disclosure;

FIG. 5 is a schematic diagram of an obtained third sample image provided in an embodiment of the present disclosure;

FIG. 6 is a schematic diagram of an obtained second sample image provided in an embodiment of the present disclosure;

FIG. 7 is a flow diagram of a method for determining the second sample image provided in an embodiment of the present disclosure;

FIG. 8 is a schematic diagram of two second sample images provided in an embodiment of the present disclosure;

FIG. 9 is a structure schematic diagram of an image generation apparatus provided in an embodiment of the present disclosure;

FIG. 10 is a structure schematic diagram of another image generation apparatus provided in an embodiment of the present disclosure;

FIG. 11 is a structure schematic diagram of a video generation apparatus provided in the present disclosure;

FIG. 12 is a structure schematic diagram of a training apparatus for the video generation model provided in the present disclosure;

FIG. 13 is a hardware schematic diagram of an electronic device provided in an embodiment of the present disclosure; and

FIG. 14 is a hardware schematic diagram of a model training device provided in an embodiment of the present disclosure.

By the above drawings, clear embodiments of the present disclosure are already shown, and more detailed descriptions are provided in the following text. These drawings and text descriptions are not intended to limit the scope of concepts of the present disclosure in any way, but rather to describe the concepts of the present disclosure to those skilled in the art by referring to specific embodiments.

### DETAILED DESCRIPTION

Here, exemplary embodiments are described in detail, and its examples are represented in the drawings. When the following description involves the drawings, unless otherwise indicated, the same numbers in the different drawings represent the same or similar elements. Implementation modes described in the following exemplary embodiments do not represent all implementation modes consistent with the present disclosure. On the contrary, they are only examples of apparatuses and methods consistent with some aspects of the present disclosure as detailed in the appended claims.

In related technologies, designers design a 3D animal facial image prop (or a 3D animal head cover) as facial images of other specific animals, and replace a facial image of a family pet included in a video with the 3D animal facial image prop (or the 3D animal head cover), to obtain a new video. In the above process, the 3D animal facial image prop (or the 3D animal head cover) is used to replace the facial image of the family pet included in the video, to obtain the new video. This results in poor combination between the 3D animal facial image prop (or the 3D animal head cover) and the facial image of the family pet in the new video, leading to the poor quality of the new video.

In the present disclosure, in order to improve the quality of the new video, the inventor thinks of using a video generation model with a small data calculation amount to process a first video, to obtain a second video (namely the new video). In the second video, an object image in the second video is generated based on a preset animal image and a first object image in a target image, so that the combination of the preset animal image and the first object image is good, thereby the quality of the second video is improved.

An application scene of a video generation method provided in the present disclosure is described below by using an example that the preset animal image is a tiger image and the first object image is a pet dog image in combination with FIG. 1.

FIG. 1 is a schematic diagram of an application scene of a video generation method provided in an embodiment of the present disclosure. As shown in FIG. 1, it includes: a target image, a plurality of first sample images, an initial video generation model, a video generation model, an original image, and a generated image.

The video generation model is obtained by training the initial video generation model using a plurality of sample image pairs. Herein, the plurality of the sample image pairs is obtained based on the target image and the plurality of the first sample images.

The video generation model is used to process the original image, to obtain the generated image. The generated image has features of the target image and the original image.

Technical schemes of the present disclosure and how to solve the above technical problems by the technical schemes of the present disclosure are described in detail below by specific embodiments. The following specific embodiments may be combined with each other, and the same or similar concepts or processes may not be repeatedly described in some embodiments. The embodiments of the present disclosure are described below in combination with the drawings.

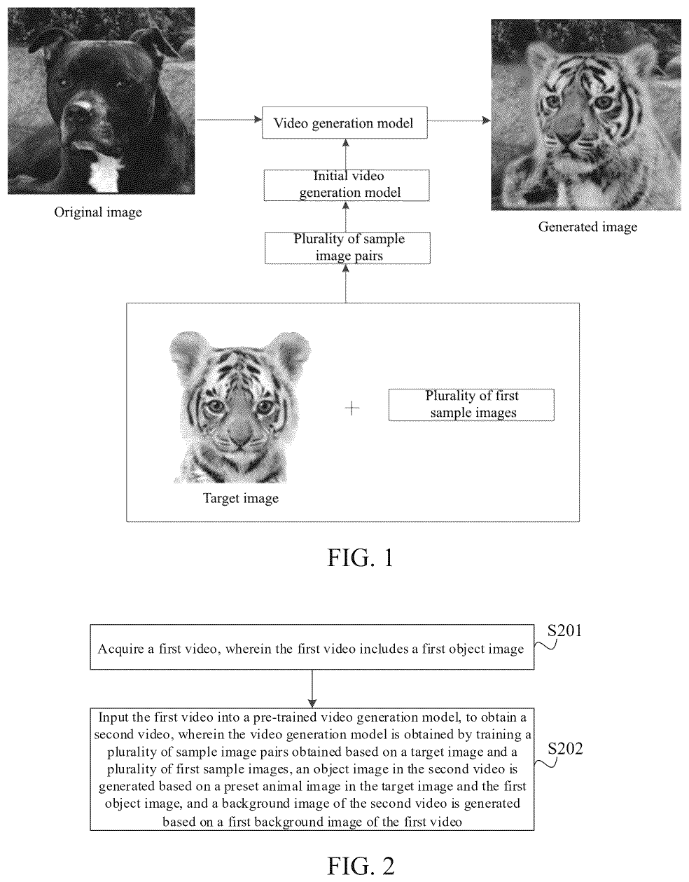

FIG. 2 is a flow diagram of the video generation method provided in the present disclosure. As shown in FIG. 2, the method includes:

S201, a first video is acquired, and the first video includes a first object image.

Optionally, the executive subject of the present disclosure may be an electronic device or a video generation apparatus arranged in the electronic device, and the video generation apparatus may be implemented by a combination of software and/or hardware. The hardware includes but not limited to a graphics processing unit (GPU). The calculation speed of GPU may be faster or slower. In the present disclosure, since the calculation speed of GPU may be faster or slower, the range of the electronic device capable of deploying the video generation method provided in the present disclosure is wider.

For example, when the calculation speed of GPU is slower, the electronic device may be a personal digital assistant (PDA), and user equipment (ULE). UE may be, for example, a smart phone.

Optionally, the first video may be a video captured in real time by the electronic device or a video pre-stored in the electronic device. The first video includes N frames of original images. N is an integer greater than or equal to 2.

Optionally, the first object image may be an animal image or a person image in the original image.

S202, the first video is input into a pre-trained video generation model, to obtain a second video.

The video generation model is obtained by training the plurality of the sample image pairs obtained based on the target image and the plurality of the first sample images.

An object image in the second video is generated based on the preset animal image and the first object image in the target image, and a background image in the second video is generated based on a first background image in the first video.

The second video includes N frames of generated images (including N frames of the generated images corresponding to the original images separately). Specifically, for each frame of the original image in the first video, the video generation model processes the original image, to obtain the generated image corresponding to the original image in the second video.

Optionally, the preset animal image may be an image of any one animal in twelve Chinese zodiac signs, as well as images of other animals.

When the first object image is the animal image, an animal indicated by the first object image and an animal indicated by the preset animal image may be different.

For example, when the animal indicated by the preset animal image is a tiger, the animal indicated by the first object image may be a cat, a dog, a deer or the like.

Different from existing technologies, in the existing technologies, the 3D animal facial image prop is used to replace the facial image of the family pet included in the video, so that the combination between the 3D animal facial image prop and the facial image of the family pet is poor, and the trueness is low, thereby the quality of the new video is reduced.

In the video generation method provided in the embodiment of FIG. 2 of the present disclosure, the object image in the second video is obtained on the basis of good combination between the preset animal image and the first object image, and the background image in the second video is generated based on the first background image in the first video, rather than directly replacing the first object image with the preset animal image. Therefore, the combination between the preset animal image and the first object image is good and the trueness is high, thus the quality of the second video is improved.

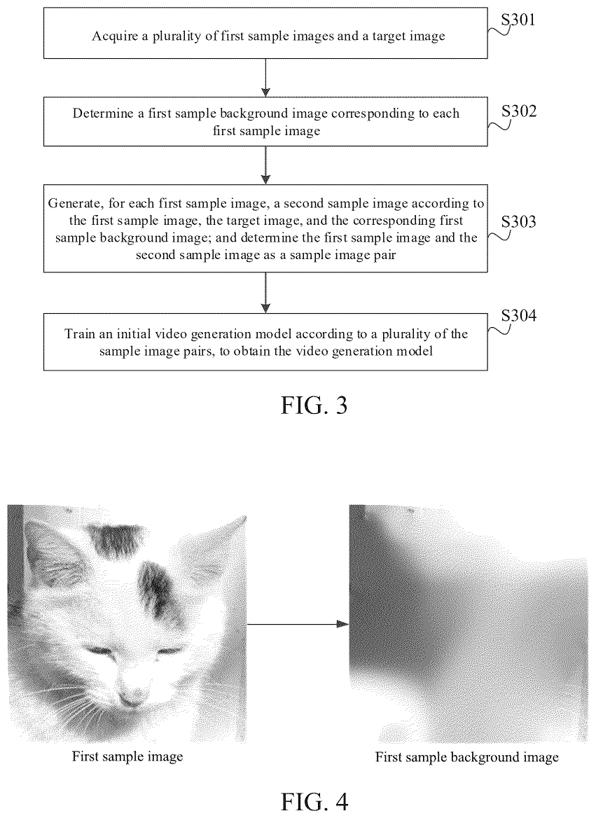

On the basis of the above embodiment, the training method for the video generation model is described below in combination with FIG. 3. Specifically, please refer to an embodiment in FIG. 3.

FIG. 3 is a flow diagram of a training method for a video generation model provided in the present disclosure. As shown in FIG. 3, the method includes:

S301, a plurality of first sample images and a target image are acquired.

Optionally, the executive subject of the training method for the video generation model may be an electronic device, or a training apparatus for the video generation model arranged in the electronic device, or a server, or a training apparatus for the video generation model arranged in the server. Herein, the training apparatus for the video generation model may be implemented by a combination of software and/or hardware.

The first sample image includes a first sample object image.

The first sample object image may be a person image or an animal image.

The target image includes a preset animal image.

When the first sample object image is the animal image, an animal indicated by the first sample object image and an animal indicated by the preset animal image may be different.

S302, a first sample background image corresponding to each first sample image is determined.

For each first sample image, the first sample background image may be obtained by the following method: an initial background image from the first sample image which excludes the first sample object image is acquired; background supplementation processing is performed on the initial background image, to obtain the first sample background image corresponding to the first sample image. In the first sample image, the initial background image and the first sample object image do not overlap.

Optionally, image segmentation processing is performed on the first sample image using a preset image segmentation model, to obtain the initial background image.

Optionally, background supplementation processing is performed on the initial background image using a preset background supplementation model, to obtain the first sample background image corresponding to the first sample image.

A schematic diagram of the first sample background image obtained is described below in combination with FIG. 4. FIG. 4 is the schematic diagram of the first sample background image provided in an embodiment of the present disclosure. As shown in FIG. 4, it includes: a first sample image and a first sample background image corresponding to the first sample image. It should be noted that FIG. 4 is an exemplary description that the animal indicated by the first sample object image is a cat.

S303, a second sample image is generated for each first sample image according to the first sample image, the target image, and the corresponding first sample background image; and the first sample image and the second sample image are determined as a sample image pair.

Herein an object image in the second sample image is generated based on the preset animal image in the target image and the first sample object image in the first sample image, and a background image of the second sample image is generated based on the corresponding first sample background image.

In a possible design, the second sample image may be generated by using the following method: the first sample image and the target image are processed by using a preset image generation model, to obtain a third sample image; an object foreground image of an object image in the third sample image is acquired; and according to the object foreground image and the first sample background image, the second sample image is determined.

It should be noted that the similarity between an expression feature of a facial image of the object image in the third sample image and an expression feature of a facial image of the first sample object image is greater than or equal to a first threshold, the similarity between a beauty feature of the facial image of the object image and a beauty feature of the facial image of the first sample object image is greater than or equal to a second threshold, and the similarity between a five-sense-organ position of the facial image of the object image and a five-sense-organ position of the facial image of the first sample object image is greater than or equal to a third threshold.

Optionally, the preset image generation model may be a pre-obtained StarGANv2 (Diverse Image Synthesis for Multiple Domains) model or a PIVQGAN (Posture and Identity Disentangled Image-to-Image Translation via Vector Quantization) model.

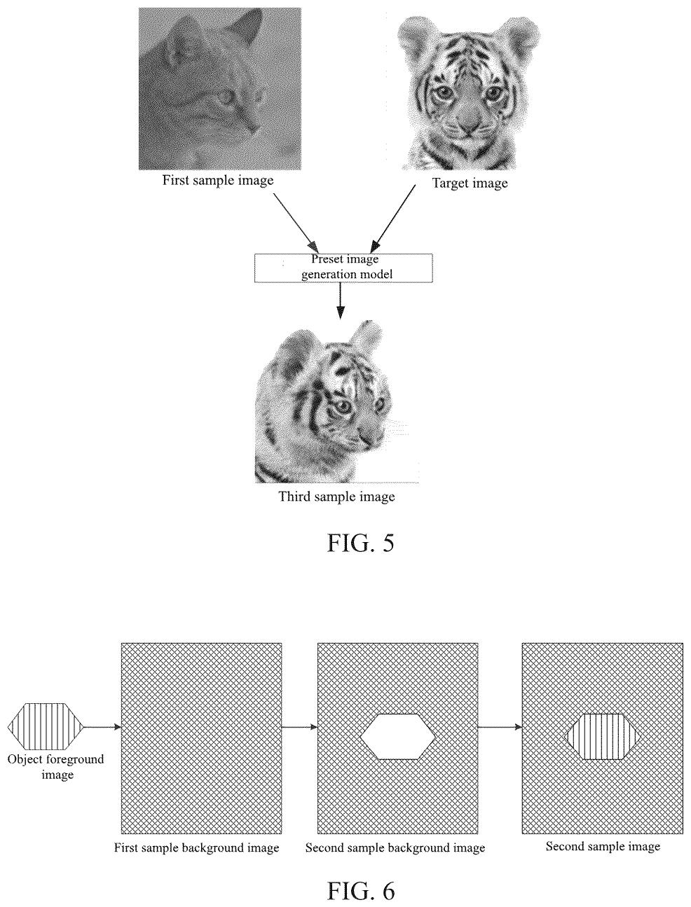

The third sample image obtained by the preset image generation model is described below in combination with FIG. 5. FIG. 5 is a schematic diagram of an obtained third sample image provided in an embodiment of the present disclosure. As shown in FIG. 5, it includes: a first sample image, a target image, a third sample image, and a preset image generation model. The preset image generation model processes the input first sample image and target image, to obtain the third sample image. A background image of the third sample image is the same as the background image in the target image.

In the present disclosure, the target image and the first sample image are processed by the preset image generation model, so that the combination between the target image and the first sample image is good, thereby the quality of the third sample image is improved, and the quality of the second sample image is improved.

Optionally, segmentation processing is performed on the third sample image using the preset image segmentation model, to obtain an object foreground image.

Optionally, the second sample image may be determined by the following Modes 11 and 12.

Mode 11, fusion processing is performed on the object background image and the first sample background image, to obtain the second sample image. Optionally, based on an alpha blending method, the fusion processing may be performed on the object background image and the first sample background image, to obtain the second sample image.

In the present disclosure, the fusion processing is performed on the object foreground image of the object image in the third sample image and the first sample background image, so that the object foreground image may be combined with the first sample background image better, thereby the quality of the second sample image is improved.

Mode 12, according to the size of the object foreground image and the position of the object foreground image in the third sample image, cut processing is performed on the first sample background image, to obtain a second sample background image; and the object foreground image is filled into the second sample background image, to obtain the second sample image. Herein, the sizes of the third sample image and the first sample image are the same. The second sample image obtained based on Mode 12 is exemplarily described below in combination with FIG. 6. FIG. 6 is a schematic diagram of an obtained second sample image provided in an embodiment of the present disclosure. As shown in FIG. 6, it includes: an object foreground image, a first sample background image, a second sample background image, and a second sample image. The second sample background image is obtained after the cut processing is performed on the first sample background image, and the second sample image is obtained after the object foreground image is filled into the second sample background image.

S304, an initial video generation model is trained according to a plurality of the sample image pairs, to obtain the video generation model.

Each of the plurality of sample image pairs includes one of the plurality of first sample images and a second sample image corresponding to the first sample image.

Optionally, the initial video generation model may be a Pix2pix model.

In the existing technologies, for the first sample image, it is necessary to manually draw a sample image corresponding to the first sample image, to obtain the sample image pair. Since it is necessary to manually draw the sample image corresponding to the first sample image in the existing technologies, the labor cost and the time cost of the sample image pair obtained are relatively high.

In the training method for the video generation model provided in the embodiment of FIG. 3, the second sample image corresponding to the first sample image is generated according to the first sample image, the target image, and the corresponding first sample background image without the need for manual drawing of the second sample image, thus the labor cost and the time cost of the sample image pair obtained may be reduced.

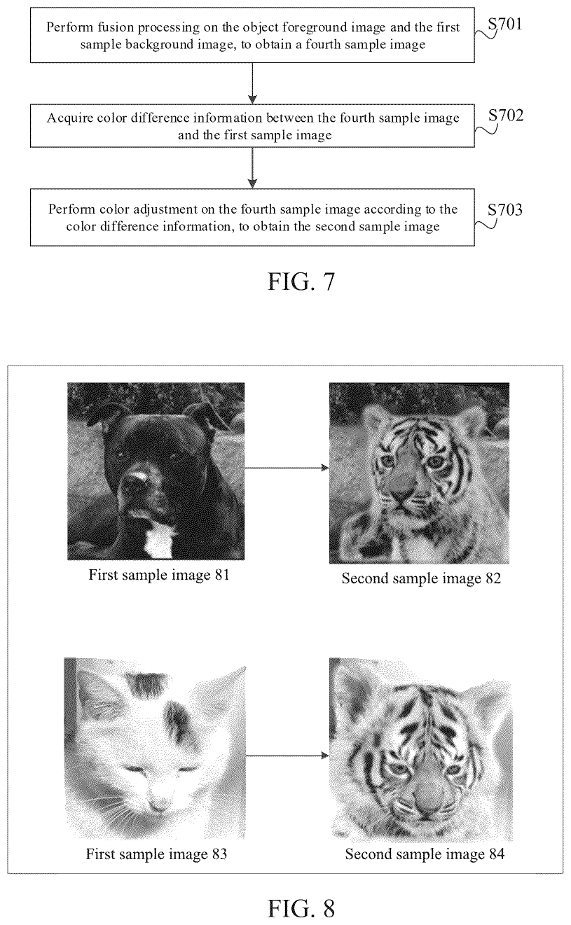

It should be noted that the present disclosure further provides a method for determining the second sample image according to the object foreground image and the first sample background image, and another method for determining the second sample image is described below in combination with FIG. 7.

FIG. 7 is a flow diagram of a method for determining the second sample image provided in an embodiment of the present disclosure. As shown in FIG. 7, the method includes:

S701, performing fusion processing on the object foreground image and the first sample background image, to obtain a fourth sample image.

Optionally, by the above method in Mode 11 or 12, the fourth sample image may be obtained after the fusion processing is performed on the object foreground image and the first sample background image.

S702, color difference information between the fourth sample image and the first sample image is acquired.

Herein, the color difference information includes a first color value corresponding to an R channel, a first color value corresponding to a G channel, and a first color value corresponding to a B channel. Optionally, the color difference information may be obtained by using the following method:
statistical processing is performed on a color value of a pixel included in the fourth sample image, to obtain a second color value corresponding to the R channel, a second color value corresponding to the G channel, and a second color value corresponding to the B channel;
statistical processing is performed on a color value of a pixel included in the first sample image, to obtain a third color value corresponding to the R channel, a third color value corresponding to the G channel, and a third color value corresponding to the B channel;
a difference value between the second color value corresponding to the R channel and the third color value corresponding to the R channel is determined as the first color value corresponding to the R channel;
a difference value between the second color value corresponding to the G channel and the third color value corresponding to the G channel is determined as the first color value corresponding to the G channel; and
a difference value between the second color value corresponding to the B channel and the third color value corresponding to the B channel is determined as the first color value corresponding to the B channel.

Optionally, in S702, it may further include: it is determined whether color formats of the fourth sample image and the first sample image are an RGB format, if so, the color difference information between the fourth sample image and the first sample image is acquired; and
otherwise, a target color format of the sample image (the fourth sample image and/or the first sample image) in non-RGB format is determined, and according to a mapping relationship between the target color format and the RGB format, the sample image in non-RGB format is converted into a sample image in RGB format, and then the color difference information between the fourth sample image and the first sample image is acquired.

For example, when the color formats of the fourth sample image and the first sample image are both a YUV format, according to a mapping relationship between the YUV format and the RGB format, the color formats of the fourth sample image and the first sample image are converted into the RGB format, and then the color difference information between the fourth sample image and the first sample image is acquired.

S703, color adjustment is performed on the fourth sample image according to the color difference information, to obtain the second sample image.

Optionally, the color adjustment is performed on the fourth sample image to obtain the second sample image by the following modes: for each pixel included in the fourth sample image, according to the first color value corresponding to the R channel, the first color value corresponding to the G channel, and the first color value corresponding to the B channel included in the color difference information, a color value of the pixel is adjusted, to obtain the second sample image.

Optionally, the color value of the pixel may be adjusted by the following Modes 21 and 22.

Mode 21, for each pixel included in the fourth sample image:
a sum of an initial color value corresponding to the R channel and the first color value corresponding to the R channel in the color value of the pixel is determined as a target color value of the color value of the pixel in the R channel;
a sum of an initial color value corresponding to the G channel and the first color value corresponding to the G channel in the color value of the pixel is determined as a target color value of the color value of the pixel in the G channel;
a sum of an initial color value corresponding to the B channel and the first color value corresponding to the B channel in the color value of the pixel is determined as a target color value of the color value of the pixel in the B channel; and
in the second sample image, the color value of the pixel includes the target color value in the R channel, the target color value in the G channel, and the target color value in the B channel.

Mode 22, for each pixel included in the fourth sample image:
a first sum value of the initial color value corresponding to the R channel and the first color value corresponding to the R channel in the color value of the pixel is determined; and a product of the first sum value and a first preset weight is determined as the target color value of the color value of the pixel in the R channel;
a second sum value of the initial color value corresponding to the G channel and the first color value corresponding to the G channel in the color value of the pixel is determined; and a product of the second sum value and a second preset weight is determined as the target color value of the color value of the pixel the G channel;
a third sum value of the initial color value corresponding to the B channel and the first color value corresponding to the B channel in the color value of the pixel is determined; and a product of the third sum value and a third preset weight is determined as the target color value of the color value of the pixel the B channel; and
In the second sample image, the color value of the pixel includes the target color value in the R channel, the target color value in the G channel, and the target color value in the B channel.

Optionally, the first preset weight, the second preset weight, and the third preset weight may be the same or different.

In the method for determining the second sample image provided in the embodiment of FIG. 7, the color difference information between the fourth sample image and the first sample image is acquired, and the color adjustment is performed on the fourth sample image according to the color difference information, to obtain the second sample image, which may guarantee that the object image in the second sample image and the first sample object image have a matching feature, thereby the quality of the second sample image is improved. For example, when the animal indicated by the first sample object image is a dark haired animal, the animal indicated by the object image in the second sample image is also a dark haired animal. For example, when the animal indicated by the first sample object image is a light haired animal, the animal indicated by the object image in the second sample image is also a light haired animal.

Further, in the present disclosure, since the quality of the second sample image is improved, the accuracy of the video generation model may be improved when the video generation model is obtained based on the sample image pair determined by the second sample image, thereby the quality of the second video obtained is improved.

FIG. 8 is a schematic diagram of two second sample images provided in an embodiment of the present disclosure. As shown in FIG. 8, it includes: a first sample image 81, a second sample image 82, a first sample image 83, and a second sample image 84. Herein, the first sample image 81 corresponds to the second sample image 82, and the first sample image 83 corresponds to the second sample image 84. It should be noted that the target image used in FIG. 8 is the target image shown in FIG. 1.

The animal indicated by the first sample object image in the first sample image 81 is a dark haired animal, and the animal indicated by the object image in the second sample image 82 is also a dark haired animal.

The animal indicated by the first sample object image in the first sample image 83 is a light haired animal, and the animal indicated by the object image in the second sample image 84 is also a light haired animal.

Different from the existing technologies, in the existing technologies, the 3D animal facial image prop is used to replace the facial image of the family pet included in the video, and there is a problem that the 3D animal facial image prop may not self-adapt to the facial image of the family pet (for example: according to the length of a nose in the facial image of the family pet, the length of an animal nose in the 3D animal facial image prop is adjusted), thus the new video generated is poor in quality.

In the present disclosure, according to the first sample image 81 and the second sample image 82 shown in FIG. 8, as well as the target image in FIG. 1, it may be seen that the facial image of the preset object image in the target image may be self-adaptively adjusted based on the facial image of the first sample object image in the first sample image 81, so that the second sample image and the first sample image have a high degree of matching, and the quality of the second sample image is improved.

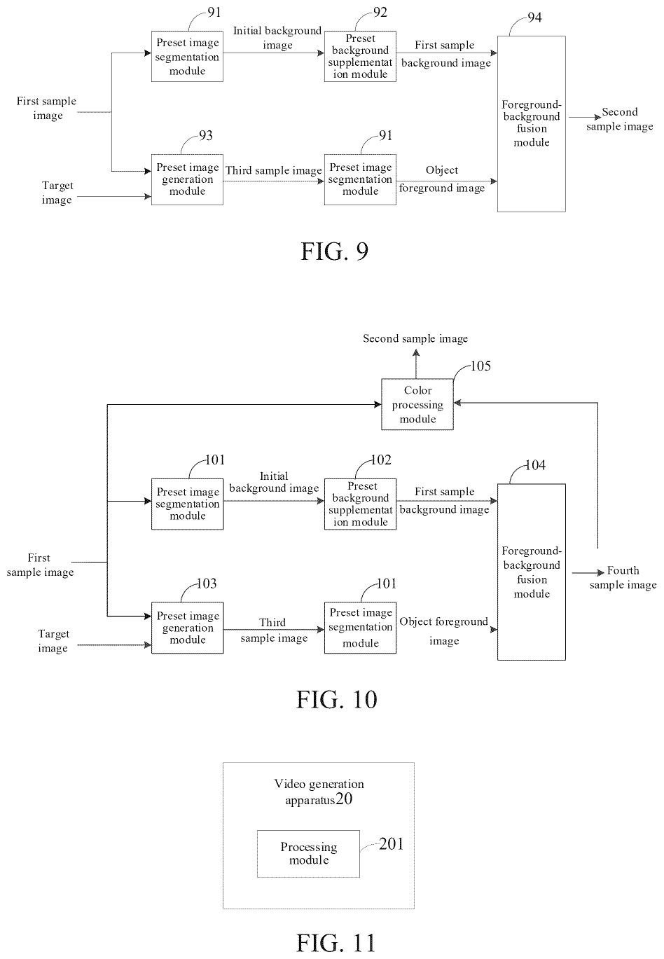

FIG. 9 is a structure schematic diagram of an image generation apparatus provided in an embodiment of the present disclosure. The generation apparatus shown in FIG. 9 may be used to obtain a second sample image. As shown in FIG. 9, the apparatus includes: a preset image segmentation module 91, a preset background supplementation module 92, a preset image generation module 93, and a foreground-background fusion module 94.

The preset image segmentation module 91 is used to perform image segmentation processing on a first sample image using a preset image segmentation model, to obtain an initial background image from the first sample image which excludes a first sample object image.

The preset background supplementation module 92 is used to perform background supplementation processing on the initial background image using a preset background supplementation model, to obtain a first sample background image.

The preset image generation module 93 is used to process the first sample image and a target image, to obtain a third sample image.

The preset image segmentation module 91 is further used to perform image segmentation processing on the third sample image using the preset image segmentation model, to obtain an object foreground image.

The foreground-background fusion module 94 is used to perform fusion processing on the object foreground image and the first sample background image, to obtain the second sample image.

FIG. 10 is a structure schematic diagram of another image generation apparatus provided in an embodiment of the present disclosure. The generation apparatus shown in FIG. 10 may be used to obtain a second sample image. As shown in FIG. 10, the apparatus includes: a preset image segmentation module 101, a preset background supplementation module 102, a preset image generation module 103, a foreground-background fusion module 104, and a color processing module 105.

The preset image segmentation module 101 is used to perform image segmentation processing on a first sample image using a preset image segmentation model, to obtain an initial background image from the first sample image which excludes a first sample object image.

The preset background supplementation module 102 is used to perform background supplementation processing on the initial background image using a preset background supplementation model, to obtain a first sample background image.

The preset image generation module 103 is used to process the first sample image and a target image, to obtain a third sample image.

The preset image segmentation module 101 is further used to perform image segmentation processing on the third sample image using the preset image segmentation model, to obtain an object foreground image.

The foreground-background fusion module 104 is used to perform fusion processing on the object foreground image and the first sample background image, to obtain a fourth sample image.

The color processing module 105 is used to obtain color difference information between the fourth sample image and the first sample image, and perform color adjustment on the fourth sample image according to the color difference information, to obtain the second sample image.

FIG. 11 is a structure schematic diagram of a video generation apparatus provided in the present disclosure. As shown in FIG. 11, the video generation apparatus 20 includes: a processing module 201, and the processing module 201 is used to:
acquire a first video, wherein the first video includes a first object image; and
input the first video into a pre-trained video generation model, to obtain a second video, wherein the video generation model is obtained by training a plurality of sample image pairs obtained based on a target image and a plurality of first sample images, the object image in the second video is generated based on a preset animal image in the target image and the first object image, and a background image of the second video is generated based on a first background image of the first video.

The video generation apparatus 20 provided in the embodiment of the present disclosure may execute the above video generation method, and its implementation principles and beneficial effects are similar, it is not repeatedly described here.

In a possible design, each of the plurality of sample image pairs includes one of the plurality of first sample images and a second sample image corresponding to the first sample image; and the second sample image is obtained based on the first sample image, the target image, and a first sample background image corresponding to the first sample image.

In a possible design, the first sample image includes a first sample object image and an initial background image; the first sample object image and the initial background image do not overlap; and the first sample background image is an image obtained after performing background supplementation processing on the initial background image.

In a possible design, the second sample image is obtained based on the first sample background image and an object foreground image of an object image in a third sample image; and the third sample image is obtained based on the first sample image and the target image, and the object image in the third sample image is generated based on the preset animal image and the first sample object image.

In a possible design, the second sample image is obtained by performing fusion processing on the first sample background image and the object foreground image.

In a possible design, the second sample image is obtained based on color difference information and a fourth sample image; the color difference information is obtained based on the fourth sample image and the first sample image; and the fourth sample image is obtained based on the object foreground image and the first sample background image.

In a possible design, the color difference information includes a first color value corresponding to an R channel, a first color value corresponding to a G channel, and a first color value corresponding to a B channel; the first color value corresponding to the R channel is obtained based on a second color value corresponding to the R channel and a third color value corresponding to the R channel, the first color value corresponding to the G channel is obtained based on a second color value corresponding to the G channel and a third color value corresponding to the G channel, and the first color value corresponding to the B channel is obtained based on a second color value corresponding to the B channel and a third color value corresponding to the B channel; the second color value corresponding to the R channel, the second color value corresponding to the G channel, and the second color value corresponding to the B channel are obtained based on a color value of a pixel included in the fourth sample image respectively; and the third color value corresponding to the R channel, the third color value corresponding to the G channel, and the third color value corresponding to the B channel are obtained based on a color value of a pixel included in the first sample image respectively.

The video generation apparatus 20 provided in the embodiment of the present disclosure may execute the above video generation method, and its implementation principles and beneficial effects are similar, it is not repeatedly described here.

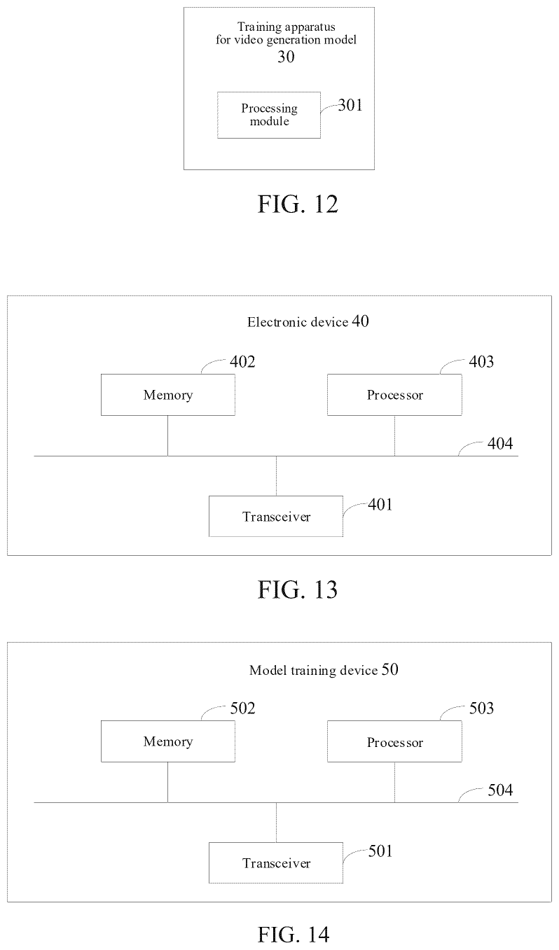

FIG. 12 is a structure schematic diagram of a training apparatus for the video generation model provided in the present disclosure. As shown in FIG. 12, the training apparatus 30 for the video generation model includes: a processing module 301, and the processing module 301 is used to:
acquire a plurality of first sample images and a target image;
determine a first sample background image corresponding to each first sample image of the plurality of first sample images;
generate, for each first sample image, a second sample image according to the first sample image, the target image, and the corresponding first sample background image; and
determine the first sample image and the second sample image as a sample image pair, wherein an object image in the second sample image is generated based on a preset animal image in the target image and a first sample object image in the first sample image, and a background image of the second sample image is generated based on the corresponding first sample background image; and
train an initial video generation model according to a plurality of the sample image pairs, to obtain the video generation model.

The training apparatus 30 for the video generation model provided in the embodiment of the present disclosure may execute the above training method for the video generation model, and its implementation principles and beneficial effects are similar, it is not repeatedly described here.

In a possible design, the processing module 301 is specifically used to: acquire for each first sample image, an initial background image from the first sample image which excludes the first sample object image; and perform background supplementation processing on the initial background image, to obtain a first sample background image corresponding to the first sample image.

In a possible design, the processing module 301 is specifically used to: process the first sample image and the target image by using a preset image generation model, to obtain a third sample image, wherein an object image in the third sample image is generated based on the preset animal image and the first sample object image; acquire an object foreground image of the object image in the third sample image; and according to the object foreground image and the first sample background image, determine the second sample image.

In a possible design, the processing module is specifically used to: perform fusion processing on the object foreground image and the first sample background image, to obtain the second sample image.

In a possible design, the processing module 301 is specifically used to: perform fusion processing on the object foreground image and the first sample background image, to obtain a fourth sample image; acquire color difference information between the fourth sample image and the first sample image; and perform color adjustment on the fourth sample image according to the color difference information, to obtain the second sample image.

In a possible design, the color difference information includes a first color value corresponding to an R channel, a first color value corresponding to a G channel, and a first color value corresponding to a B channel; the processing module 301 is specifically used to: perform statistical processing on a color value of a pixel included in the fourth sample image, to obtain a second color value corresponding to the R channel, a second color value corresponding to the G channel, and a second color value corresponding to the B channel; perform statistical processing on a color value of a pixel included in the first sample image, to obtain a third color value corresponding to the R channel, a third color value corresponding to the G channel, and a third color value corresponding to the B channel; determine a difference value between the second color value corresponding to the R channel and the third color value corresponding to the R channel as the first color value corresponding to the R channel; determine a difference value between the second color value corresponding to the G channel and the third color value corresponding to the G channel as the first color value corresponding to the G channel; and determine a difference value between the second color value corresponding to the B channel and the third color value corresponding to the B channel as the first color value corresponding to the B channel.

In a possible design, the processing module 301 is specifically used to: for each pixel included in the fourth sample image, according to the first color value corresponding to the R channel, the first color value corresponding to the G channel, and the first color value corresponding to the B channel included in the color difference information, perform adjustment on a color value of the pixel, to obtain the second sample image.

The training apparatus 30 for the video generation model provided in the embodiment of the present disclosure may execute the above training method for the video generation model, and its implementation principles and beneficial effects are similar, it is not repeatedly described here.

FIG. 13 is a hardware schematic diagram of an electronic device provided in an embodiment of the present disclosure. As shown in FIG. 13, the electronic device 40 may include: a transceiver 401, a memory 402, and a processor 403.

Herein, the transceiver 401 may include: a transmitter and/or a receiver. The transmitter may also be referred to as a sender, a transmission machine, a transmission port, or a transmission interface, or other similar descriptions. The receiver may also be referred to as an acceptor, a receiving machine, a receiving port, or a receiving interface, or other similar descriptions.

Exemplarily, the transceiver 401, the memory 402, and the processor 403 are connected to each other by a bus 404.

The memory 402 is used to store computer execution instructions.

The processor 403 is used to execute the computer execution instructions stored in the memory 402, so that the processor 403 executes the above video generation method.

FIG. 14 is a hardware schematic diagram of a model training device provided in an embodiment of the present disclosure. Optionally, the model training device may be the above electronic device or the above server. As shown in FIG. 14, the model training device 50 may include: a transceiver 501, a memory 502, and a processor 503.

Herein, the transceiver 501 may include: a transmitter and/or a receiver. The transmitter may also be referred to as a sender, a transmission machine, a transmission port, or a transmission interface, or other similar descriptions. The receiver may also be referred to as an acceptor, a receiving machine, a receiving port, or a receiving interface, or other similar descriptions.

Exemplarily, the transceiver 501, the memory 502, and the processor 503 are connected to each other by a bus 504.

The memory 502 is used to store computer execution instructions.

The processor 503 is used to execute the computer execution instructions stored in the memory 502, so that the processor 503 executes the above training method for the video generation model.

An embodiment of the present disclosure further provides a computer-readable storage medium, the computer-readable storage medium stores computer execution instructions, and when the computer execution instructions are executed by a processor, the above video generation method and the training method for the video generation model are implemented.

An embodiment of the present disclosure further provides a computer program product, including a computer program, wherein when the computer program is executed by a processor, the above video generation method and the training method for the video generation model may be implemented.

An embodiment of the present disclosure further provides a computer program, when the computer program is executed by a processor, the above video generation method and the training method for the video generation model may be implemented.

All or part of steps to implement the above method embodiments may be completed by hardware related to program instructions. The aforementioned program may be stored in a readable memory. When the program is executed, the steps including the above method embodiments are executed; and the aforementioned memory (storage medium) includes: a read-only memory (ROM), a random access memory (RAM), a flash memory, a hard disk, a solid-state drive, a magnetic tape, a floppy disk, an optical disc, and any combinations thereof.

The embodiments of the present disclosure are described with reference to flow diagrams and/or block diagrams of methods, devices (systems), and computer program products according to the embodiments of the present disclosure. It should be understood that each process and/or block in the flow diagrams and/or block diagrams, as well as combinations of the processes and/or blocks in the flow diagrams and/or block diagrams, may be implemented by computer program instructions. These computer program instructions may be provided to processing units of a general-purpose computer, a special-purpose computer, an embedded processor, or other programmable data processing devices to generate a machine, so that an apparatus for implementing functions specified in one or more flows in the flow diagrams and/or one or more blocks in the block diagrams is generated by the instructions executed by the processing units of the computers or other programmable data processing devices.

These computer program instructions may also be stored in a computer-readable memory that may guide the computers or other programmable data processing devices to work in specific ways, so that the instructions stored in the computer-readable memory generate a manufacturing product including an instruction apparatus, and the instruction apparatus implements the functions specified in one or more flows in the flow diagrams and/or one or more blocks in the block diagrams.

These computer program instructions may also be loaded on the computers or other programmable data processing devices, so that a series of operation steps are executed on the computers or other programmable data processing devices to generate computer-implemented processing, thereby the instructions executed on the computers or other programmable data processing devices provide the steps for implementing the functions specified in one or more flows in the flow diagrams and/or one or more blocks in the block diagrams.

Apparently, those skilled in the art may make various modifications and variations to the embodiments of the present disclosure without departing from the spirit and scope of the present disclosure. In this way, if these modifications and variations of the embodiments of the present disclosure fall within the scope of the claims of the present disclosure and equivalent technologies thereof, the present disclosure also intends to include these modifications and variations.

In the present disclosure, the term “including” and variations thereof may refer to non-restrictive including; and the term “or” and variations thereof may refer to “and/or”. The terms “first”, “second” and the like used in the present disclosure are used to distinguish similar objects and are not necessarily used to describe a specific sequence or a precedence order. In the present disclosure, “plurality” refers to two or more. “and/or” describes an association relationship of associated objects, it is indicated that there may be three types of relationships, such as A and/or B may represent three situations: existence of A alone, coexistence of A and B, and existence of B alone. The character “/” generally represents that the front and back associated objects are an “or” relationship.

Those skilled in the art, after considering the description and practicing the present disclosure disclosed herein, may easily think of other implementation modes of the present disclosure. The present disclosure aims to encompass any variations, uses, or adaptive changes of the present disclosure, and these variations, uses, or adaptive changes follow the general principles of the present disclosure and include well-known common knowledge or customary technical means in the field of technologies that are not disclosed in the present disclosure. The description and embodiments are only considered exemplary, and the true scope and spirit of the present disclosure are indicated in the claims below.

It should be understood that the present disclosure is not limited to the precise structures already described above and shown in the drawings, and various modifications and changes may be made without departing from its scope. The scope of the present disclosure is limited only by the appended claims.

What is claimed is:

1. A video generation method, comprising:
acquiring a first video, wherein the first video comprises a first object image; and
inputting the first video into a pre-trained video generation model, to obtain a second video, wherein the video generation model is obtained by training a plurality of sample image pairs obtained based on a target image and a plurality of first sample images, an object image in the second video is generated based on a preset animal image in the target image and the first object image, and a background image of the second video is generated based on a first background image of the first video.

2. The method according to claim 1, wherein
each of the plurality of sample image pairs comprises one of the plurality of first sample images and a second sample image corresponding to the first sample image; and
the second sample image is obtained based on the first sample image, the target image, and a first sample background image corresponding to the first sample image.

3. The method according to claim 2, wherein each of the plurality of first sample images comprises a first sample object image and an initial background image; the first sample object image and the initial background image do not overlap; and
the first sample background image is an image obtained after performing background supplementation processing on the initial background image.

4. The method according to claim 2, wherein
the second sample image is obtained based on the first sample background image and an object foreground image of an object image in a third sample image; and
the third sample image is obtained based on the first sample image and the target image, and the object image in the third sample image is generated based on the preset animal image and the first sample object image.

5. The method according to claim 4, wherein
the second sample image is obtained by performing fusion processing on the first sample background image and the object foreground image.

6. The method according to claim 4, wherein
the second sample image is obtained based on color difference information and a fourth sample image;
the color difference information is obtained based on the fourth sample image and the first sample image; and
the fourth sample image is obtained based on the object foreground image and the first sample background image.

7. The method according to claim 6, wherein the color difference information comprises a first color value corresponding to an R channel, a first color value corresponding to a G channel, and a first color value corresponding to a B channel;
the first color value corresponding to the R channel is obtained based on a second color value corresponding to the R channel and a third color value corresponding to the R channel, the first color value corresponding to the G channel is obtained based on a second color value corresponding to the G channel and a third color value corresponding to the G channel, and the first color value corresponding to the B channel is obtained based on a second color value corresponding to the B channel and a third color value corresponding to the B channel;
the second color value corresponding to the R channel, the second color value corresponding to the G channel, and the second color value corresponding to the B channel are obtained based on a color value of a pixel comprised in the fourth sample image respectively; and
the third color value corresponding to the R channel, the third color value corresponding to the G channel, and the third color value corresponding to the B channel are obtained based on a color value of a pixel comprised in the first sample image respectively.

8. A training method for a video generation model, comprising:
acquiring a plurality of first sample images and a target image;
determining a first sample background image corresponding to each first sample image of the plurality of first sample images;
for each first sample image, generating a second sample image according to the first sample image, the target image, and a corresponding first sample background image; and determining the first sample image and the second sample image as a sample image pair, wherein an object image in the second sample image is generated based on a preset animal image in the target image and a first sample object image in the first sample image, and a background image of the second sample image is generated based on the corresponding first sample background image; and
training an initial video generation model according to a plurality of sample image pairs, to obtain the video generation model.

9. The method according to claim 8, wherein the determining a first sample background image corresponding to each first sample image of the plurality of first sample images, comprising:
acquiring, for each first sample image, an initial background image from the first sample image which excludes the first sample object image; and
performing background supplementation processing on the initial background image, to obtain a first sample background image corresponding to the first sample image.

10. The method according to claim 9, wherein the generating a second sample image according to the first sample image, the target image, and a corresponding first sample background image comprises:
processing the first sample image and the target image, by using a preset image generation model, to obtain a third sample image, wherein an object image in the third sample image is generated based on the preset animal image and the first sample object image;
acquiring an object foreground image of the object image in the third sample image; and
determining the second sample image according to the object foreground image and the first sample background image.

11. The method according to claim 10, wherein the determining the second sample image according to the object foreground image and the first sample background image comprises:
performing fusion processing on the object foreground image and the first sample background image, to obtain the second sample image.

12. The method according to claim 10, wherein the determining the second sample image according to the object foreground image and the first sample background image comprises:
performing fusion processing on the object foreground image and the first sample background image, to obtain a fourth sample image;
acquiring color difference information between the fourth sample image and the first sample image; and
performing color adjustment on the fourth sample image according to the color difference information, to obtain the second sample image.

13. The method according to claim 12, wherein the color difference information comprises a first color value corresponding to an R channel, a first color value corresponding to a G channel, and a first color value corresponding to a B channel; the acquiring color difference information between the fourth sample image and the first sample image comprises:
performing statistical processing on a color value of a pixel comprised in the fourth sample image, to obtain a second color value corresponding to the R channel, a second color value corresponding to the G channel, and a second color value corresponding to the B channel;
performing statistical processing on a color value of a pixel comprised in the first sample image, to obtain a third color value corresponding to the R channel, a third color value corresponding to the G channel, and a third color value corresponding to the B channel;
determining a difference value between the second color value corresponding to the R channel and the third color value corresponding to the R channel as the first color value corresponding to the R channel;
determining a difference value between the second color value corresponding to the G channel and the third color value corresponding to the G channel as the first color value corresponding to the G channel; and
determining a difference value between the second color value corresponding to the B channel and the third color value corresponding to the B channel as the first color value corresponding to the B channel.

14. The method according to claim 13, wherein the performing the color adjustment on the fourth sample image according to the color difference information, to obtain the second sample image comprises:
performing, for each pixel comprised in the fourth sample image, adjustment on a color value of the pixel according to the first color value corresponding to the R channel, the first color value corresponding to the G channel, and the first color value corresponding to the B channel comprised in the color difference information, to obtain the second sample image.

15. (canceled)

16. An image generation apparatus, comprising: a preset image segmentation module, a preset background supplementation module, a preset image generation module, a foreground-background fusion module, and a color processing module; wherein
the preset image segmentation module is configured to perform image segmentation processing on a first sample image using a preset image segmentation model, to obtain an initial background image from the first sample image which excludes a first sample object image;
the preset background supplementation module is configured to perform background supplementation processing on the initial background image using a preset background supplementation model, to obtain a first sample background image;
the preset image generation module is configured to process the first sample image and a target image, to obtain a third sample image;
the preset image segmentation module is further configured to perform image segmentation processing on the third sample image using the preset image segmentation model, to obtain an object foreground image;
the foreground-background fusion module is configured to perform fusion processing on the object foreground image and the first sample background image, to obtain a fourth sample image; and
the color processing module is configured to obtain color difference information between the fourth sample image and the first sample image, and perform color adjustment on the fourth sample image according to the color difference information, to obtain a second sample image.

17. An electronic device, comprising: a processor and a memory connected in communication with the processor;
the memory stores computer execution instructions; and
the processor executes the computer execution instructions stored in the memory to implement the method according to claim 1.

18. A model training device, comprising: a processor and a memory connected in communication with the processor;
the memory stores computer execution instructions; and
the processor executes the computer execution instructions stored in the memory to implement the method according to claim 8.

19. A computer-readable storage medium, wherein the computer-readable storage medium stores computer execution instructions, and when the computer execution instructions are executed by a processor, the method according to claim 1 is implemented.

20. A computer program product, comprising a computer program, wherein when the computer program is executed by a processor, the method according to claim 8 is implemented.

21. A computer program, wherein when the computer program is executed by a processor, the method according to claim 1 is implemented.
